(19) United States
(12) Patent Application Publication
(10) Pub. No.: US 2014/0222941 A1
(43) Pub. Date: Aug. 7, 2014

(54) AD-HOC DEVICE SHARING OVER A NETWORK

(71) Applicant: Google Inc., Mountain View, CA (US)

(72) Inventors: Ryan TABONE, San Francisco, CA (US); Edward Weili CHIANG, San Francisco, CA (US)

(73) Assignee: Google Inc., Mountain View, CA (US)

(21) Appl. No.: 13/762,293

(22) Filed: Feb. 7, 2013

(51) Int. Cl. H04L 12/70

(52) U.S. Cl. CPC H04L 47/781
USPC 709/208

(57) ABSTRACT

The subject technology discloses implementations for an ad-hoc sharing service that provides a solution for end-to-end connectivity of one or more master computing devices to access different resources of one or more host computing devices that are available to be utilized (e.g., depending on the desired usage of the master computing device(s) and the respective capabilities of each device). Example resources on a given device include, but are not limited to, display, audio, network, storage, processing, input and output peripherals, etc. The ad-hoc sharing service can initially determine available resources of each device for sharing.

### BACKGROUND

Typically, in order for another computing device (e.g., computer, laptop, netbook, tablet, etc.) to access a host computing device and/or any of its peripherals, control of the host computing device (which has a physical connection to the peripheral device), and/or a dedicated link to the computing device is required. In addition, some solutions may require specialized software to be installed on each device and multiple configuration steps that increase the difficulty of sharing resources between different devices.

### SUMMARY

The subject technology provides a computer-implemented method for ad-hoc sharing of devices. The method includes determining a plurality of host computing devices that are available for access from a master computing device; determining a set of available resources for the determined plurality of host computing devices; selecting a device among the determined plurality of host computing devices for accessing an available resource of the set of available resources; determining an optimal physical communication channel for accessing the available resource on the selected device; and accessing the resource on the selected device via the determined optimal physical communication channel

The subject technology also provides computer-implemented method for processing a request for ad-hoc sharing of a device. The method includes receiving, via a first physical communication channel, a request from a master computing device for accessing a resource on a host computing device when a geolocation of the master computing device is within a proximity threshold to the host computing device in which the host computing device includes one or more resources that are registered for sharing over a network; determining if the master computing device is authorized for accessing the resource on the host computing device; receiving, via a second physical communication channel, a request to access a resource on the selected device; determining if the master computing device has already been granted access to the resource; and transmitting a notification to the master computing device if access to the resource was previously granted to the master computing device. In some configurations, the second physical communication channel is the same as the first physical communication channel.

Yet another aspect of the subject technology provides a system for ad-hoc sharing of devices over a network. The system includes memory, one or more processors, and one or more modules stored in memory and configured for execution by the one or more processors. The system includes a device availability module configured to determine a plurality of host computing devices that are available for access from a master computing device, and determine a set of available resources for the determined plurality of host computing devices for access over a network; a device selection module configured to perform a selection of a device among the determined plurality of host computing devices for accessing an available resource of the set of available resources in which the selection of the device is based on a request over the network from the master computing device; and a device communication module configured to determine an optimal physical communication channel for communicating with the selected device over the network in order to access the available resource.

The subject technology further provides a non-transitory machine-readable medium non-transitory machine-readable medium including instructions stored therein, which when executed by a machine, cause the machine to perform operations including: determining a plurality of host computing devices that are available for access from a master computing device; determining a set of available resources for the determined plurality of host computing devices; selecting a device among the determined plurality of host computing devices for accessing an available resource of the set of available resources based on a request from the master computing device; and determining an optimal physical communication channel for accessing the available resource on the selected device.

It is understood that other configurations of the subject technology will become readily apparent to those skilled in the art from the following detailed description and various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The features of the subject technology are set forth in the appended claims. However, for purpose of explanation, several configurations of the subject technology are set forth in the following figures.

FIG. 1 conceptually illustrates master and host computing devices in an example configuration for ad-hoc sharing of resources between devices.

FIG. 2 conceptually illustrates an example process for ad-hoc sharing of devices over a network.

FIG. 3 conceptually illustrates an example process for processing a request for ad-hoc sharing of a device over a network.

FIG. 4 conceptually illustrates an example computing environment.

FIG. 5 conceptually illustrates an example application programming interface (API) architecture.

FIG. 6 conceptually illustrates a system with which some implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent that the subject technology is not limited to the specific details set forth herein and may be practiced without these specific details. In some instances, well-known structures and components are shown in block diagram form in order to avoid obscuring the concepts of the subject technology.

A given computing device includes different resources or capabilities (e.g., display, audio, network, CPU, internal and/or external peripheral devices, etc.). For conventional systems, there are no ad-hoc solutions (e.g., without requiring specialized technical knowledge, specialized software and/or hardware, or cumbersome configuration steps, etc.) for one or more computing devices to access one or more other computing devices and their available resources over a network infrastructure (Internet, intranet, etc.) or other communication channel (e.g., physical communication channel for device-to-device communication, etc.).

Typically, in order for another computing device (e.g., computer, laptop, netbook, tablet, etc.) to access a host computing device and/or any of its peripherals, control of the host computing device (which has a physical connection to the peripheral device), and/or a dedicated link to the computing device is required. In addition, conventional systems can require specialized software to be installed on each device and multiple configuration steps that increase the difficulty of sharing resources between different devices.

In an example scenario, a user wants to display information, such as a map of a weekend destination, on the respective screens of the computing devices of four friends that the user is traveling with that weekend. The user transmits the map, either as a file, a link to site with the data, or some other container of the data, directly to the four friends, who in turn display the map on their respective displays. Alternatively, the four friends have their displays connected to a computing device(s) dedicated to displaying anything the user wishes to share with the four friends.

However, the preceding examples typically require a multiplicity of steps to configure, specialized software or hardware, and/or specialized technical knowledge. For instance, each user may be required to have a remote sharing solution installed on their computer (e.g., Remote Desktop Protocol, Virtual Network Computing, etc.). A primary user would then be required to remotely connect to each of the other users' (“secondary users”) computers in order to display what the user wished to share on each of the secondary users' computers. In another example, the primary user is required to start a group video conference and each secondary user would have to join the video conference in order for the primary user to share content with each secondary user.

The issues with the above examples are that each user (e.g., primary and all secondary users) is required to visit a portal or utilize proprietary software, and then perform a joining or authorization step in order to see what the primary user wanted to share with each secondary user. However, typical solutions may not provide a one-to-multi control of a peripheral other than a display device (e.g., monitor, etc.). Additionally, typical solutions may require authorization and/or installation of specialized software for each instance in which the primary user wishes to share with secondary users.

To address the aforementioned issues, the subject technology utilizes three different main components to provide an ad-hoc device sharing solution: 1) a physical layer for providing a network infrastructure or backbone (e.g., Internet, intranet, etc.), 2) a software layer for authentication and communication channel setup, and 3) different devices for sharing. In one aspect, the subject technology provides an ad-hoc sharing service (e.g., a web service located in the cloud in one example implementation) to enable one or more master computing devices to access and utilize different resources that are available on any number of host computing devices via a given network infrastructure. Consequently, the subject technology allows any device to be shared to any number of people, and may utilize multiple methods of discovery (e.g., not strictly limited to a proprietary service on the Internet such as a propriety cloud sharing service) for accessing the device.

More specifically, the ad-hoc sharing service provides a solution for end-to-end connectivity of one or more master computing devices to access different resources of one or more host computing devices that are available to be utilized (e.g., depending on the desired usage of the master computing device(s) and the respective capabilities of each device). Example resources on a given device include, but are not limited to, display, audio, network, storage, processing, input and output peripherals, etc. The ad-hoc sharing service can initially determine available resources of each device for sharing.

For instance, a master computing device can utilize the ad-hoc sharing service to determine one or more available host computing devices (e.g., by accessing the ad-hoc sharing service via a given network infrastructure such as the Internet or local area network). By way of example, the ad-hoc sharing service initiates an authentication procedure for the master computing device and any available host computing devices. A user can have one or more devices associated with the user and, upon authentication, be able to access the devices (or other devices of other users). Availability of each host computing device can be determined based on the accessibility of the host computing device via a network infrastructure (or other physical communication channel such as a micro-network, Bluetooth, etc.).

In one example, the ad-hoc sharing service determines, via multiple discovery methods, different available communication channels of each device (e.g., Bluetooth, micro-network of devices near each other, ad-hoc network, wired, wireless, etc.) to facilitate communication between respective devices (e.g., in order to determine an optimal physical communication channel for communication). In this manner, the ad-hoc sharing service may utilize the network infrastructure for authentication (if needed) and the initial determination of available devices, and then may utilize a different physical communication channel (e.g., micro-network, ad-hoc network, Bluetooth, etc.) for establishing the communication channel for accessing the resource on the host computing device(s). However, it should be understood that the subject technology may not be required to utilize different channels. In some examples, the same communication channel may be utilized and still be within the scope of the subject technology. Further, some configurations do not require authentication at all.

One example implementation (but not necessarily limiting the scope of the subject technology) to resolve the above mentioned issues includes a web service that enables access of a host computing device over a network by another computing device (the “master” device). In one example, the web service provides an API that enables an application (e.g., web browser, web application hosted in the web browser, client front-end application, etc.) on the computing device to determine a device for accessing over the network. The web service provides a list of available devices over the network and performs authentication (if necessary) to access any of the devices. In one example, the available devices is based on a geolocation of a user, a sharing setting in a social network and/or a specified set of users. For instance, the subject technology detects the geolocation shared by a user and determines one or more available devices based on the shared geolocation (e.g., to determine a set of devices near or within a distance threshold of the geolocation of the user). In another example, one or more devices are shared utilizing a social network or based on one or more specified user set by the user that owns the devices. Further, a user-interface can be provided in a web-based operating system or browser (or any other application) to access devices over the network.

In another example, the subject technology determines different devices (e.g., input and output devices) that are available for access over a network. Each of the determined devices include one or more resources that are available for access by a master computing device. Based on the available resources of the devices, a user (or application) selects a device among the different devices. A web service interface for communicating with the selected device over a network is determined. Utilizing the web service interface, a communication channel to the device is established. A request is transmitted via the communication channel to access a resource (e.g., a display, audio, or networking component, etc.) on the device. By way of example, the request can be received by the web service and then transmitted to the owner of the requested device in order to grant access to the device. It is then determined if the request was granted via the communication channel. In one example, an authentication token is received via the communication channel granting access to the device. The resource is then accessed on the device via the communication channel if the request was granted.

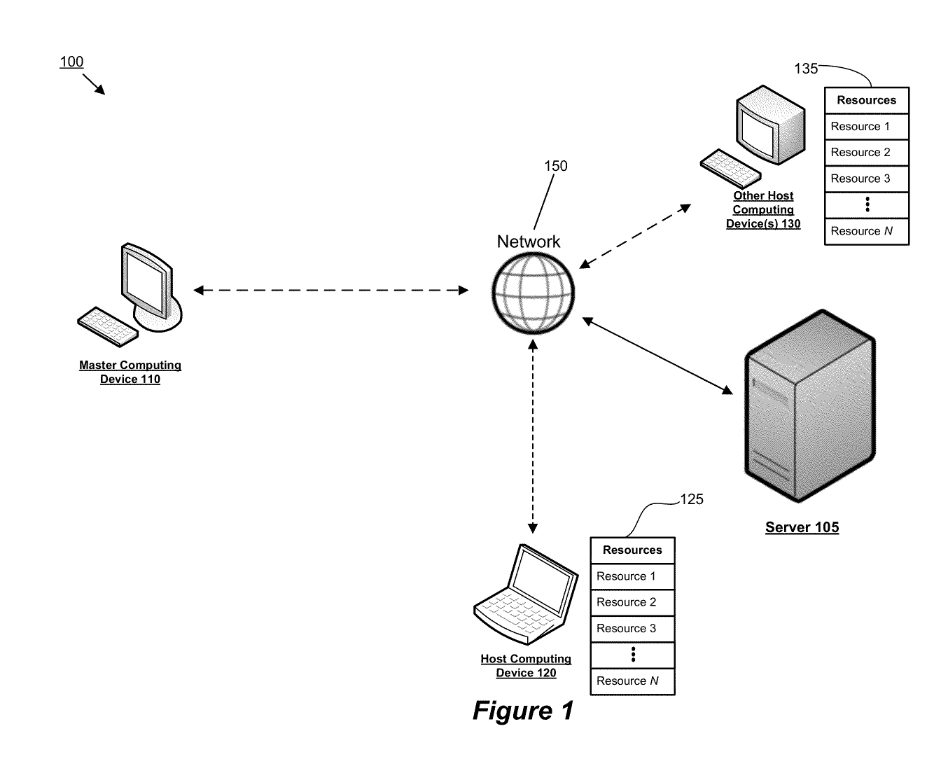

FIG. 1 conceptually illustrates master and host computing devices in an example configuration 100 for ad-hoc sharing of resources between devices. More specifically, FIG. 1 illustrates a master computing device that accesses a host computing device via an existing network infrastructure. For the sake of simplicity and not to obscure the description of the example, FIG. 1 illustrates an example in which one master computing device accesses one or more resources provided by a host computing device over an existing network infrastructure (physical layer) by utilizing a web service (software layer) provided in a server located in the cloud (e.g., network). One of ordinary skill in the art would appreciate that more than one hosting computing device and more than one master computing device may be provided and still be within the scope of the subject technology.

The subject technology enables a master computing device to determine one or more host computing devices that have available resources for sharing in an ad-hoc manner. As illustrated in the example of FIG. 1, a master computing device 110 accesses a server 105 over a network 150. The network 150 can be a local network, wide area network, or a network of networks (e.g., the Internet), etc. In one example, the server 105 provides a web service for facilitating communication between the master computing device 110 and a host computing device 120 in order to enable ad-hoc sharing of resources 125 from the host computing device 120. For instance, the master computing device 110 can utilize a client application (e.g., web browser, mobile application, etc.) running on the master computing device 110 to determine available resources for access on the host computing device 120 by initially communicating with the web service provided by the server 105. The available resources on the host computing device 120 can include peripherals externally connected to and/or located internally to the host computing device 120. Additionally, the master computing device 110 can determine resources 135 from other host computing device(s) 130 to access in a similar manner described above by utilizing the web service provided by the server 105.

To access one or more available resources on the host computing device 120, the master computing device 110 may utilize a different communication interface from a communication interface for initially communicating with the server 105 and/or the host computing device 120. For instance, a first type of communication interface may be utilized by the master computing device 110 to negotiate and authorize access to the resource (e.g., by communicating with the server 105) provided by the host computing device 120 and a second type of communication interface may be utilized to access the resource by the master computing device 110. Instead of different communication interfaces, some configurations may utilize the same communication interface for negotiating and/or authorizing access to the resource(s). Additionally, authorization is not required in all instances.

Additionally, although the example shown in FIG. 1 includes the server 105, in one example, ad-hoc sharing of resources may be accomplished via a peer-to-peer communication between the master computing device 110 and the host computing device 120 and/or the other host computing device(s) 130. In this example, the functionality of the web service provided by the server 105 is implemented by the master computing device 110 and/or any of the host computing devices. In one example, instead of the single server 105, the configuration 100 can include a respective cluster of servers/computers/computing devices that perform a same set of functions in a distributed and/or load balanced manner. A cluster can be understood as a group of servers/computers that are linked together to seamlessly perform the same set of functions, which can provide performance, reliability and availability advantages over a single server/computer architecture. In an example with a group of servers, the group of servers may be configured to provide the aforementioned web service for enabling ad-hoc sharing of resources between the master computing device 110 and host computing device 120 and other host computing device(s) 130.

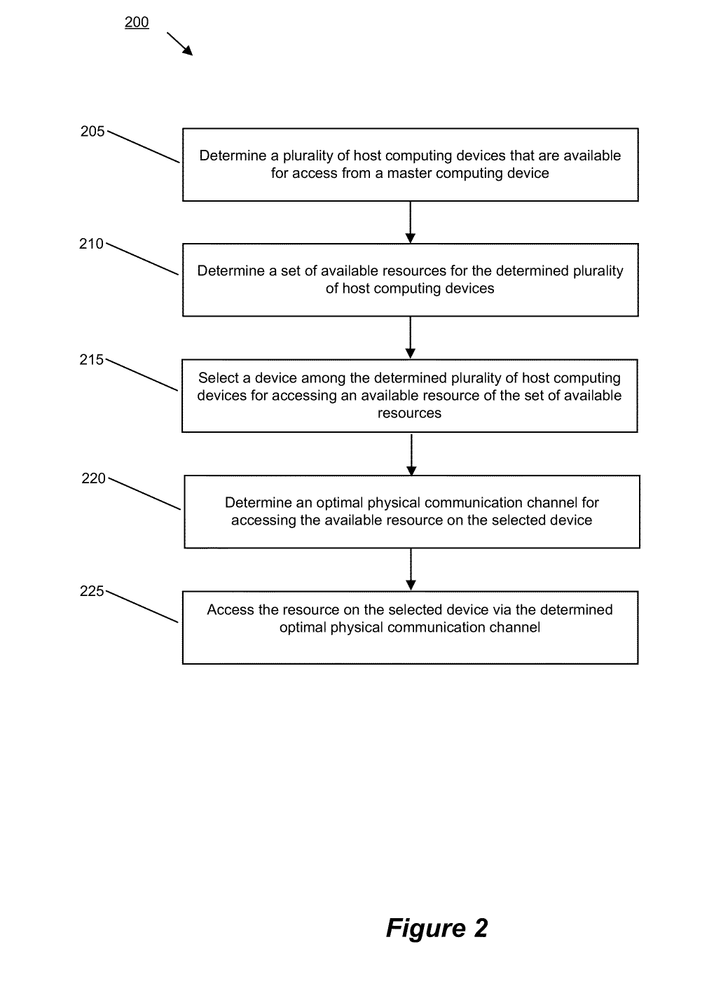

FIG. 2 conceptually illustrates an example process for ad-hoc sharing of devices over a network. The process 200 can be performed by one or more computing devices or systems in some configurations.

The process 200 begins at 205 by determining a plurality of host computing devices that are available for access from a master computing device. Determining a plurality of host computing devices that are available for access from the master computing device occurs over a network infrastructure (such as a personal area network, local area network, wide area network, network of networks, etc.) in one example. Further, determining the plurality of host computing devices is based on a geolocation of a user in one example. In this example, the geolocation of the user may correspond with a location of the master computing device. For instance, the process 200 may determine the plurality of host computing devices based on a proximity threshold based on physical distance from the master computing device. Thus, the plurality of host computing devices within the proximity threshold (e.g., a predetermined distance) from the master computing device (corresponding to the user's geolocation) may be discovered.

The process 200 at 210 determines a set of available resources for the determined plurality of host computing devices. Each of the determined host computing devices may include a set of available resources that are available for being accessed by the master computing device. The process 200 at 215 selects a device among the determined plurality of host computing devices for accessing an available resource of the set of available resources. In one example, the host computing devices includes at least one input device (e.g., any peripheral including keyboards, mice, scanners, digital cameras and joysticks, etc.) and one output device (e.g., monitor, display, LED, audio device, speakers, etc.). The one output device is a monitor in some configurations. Other types of resources can be included and still be within the scope of the subject technology.

The process 200 at 220 determines an optimal physical communication channel for accessing the available resource on the selected device. In one example, the process 200 determines the optimal physical communication channel for accessing the available resource on the selected device by determining an optimal channel based on different criteria. The criteria include available bandwidth, signal strength, signal quality, and latency in one example. Other types of criteria may be utilized and still be within the scope of the subject technology. The physical communication channel is a network connection of some form in one example. More specifically, the network connection is included in a personal area network, local area network, ad-hoc network, wide area network or network of networks, etc., and may utilize any suitable form of communication including wired and/or wireless technologies. Other types of network connections can be utilized and still be within the scope of the subject technology. The physical communication channel is an end-to-end communication channel in one example that enables the master computing device to directly access the available resource provided by the host computing devices.

The process 200 at 225 accesses the resource on the selected device via the determined optimal physical communication channel. In some configurations, the resource includes a display component, an audio component or a networking component of the device, or any peripheral on the device, etc. In one example, accessing the resource on the selected device includes transmitting data over the network for display on a display component of the selected device. Other types of access to a resource may be provided and still be within the scope of the subject technology. Once the resource is accessed on the device, a user may utilize the resource in an appropriate manner. By way of example, if the resource is a display device, the user may then share content for display to a secondary user. The process 200 then ends.

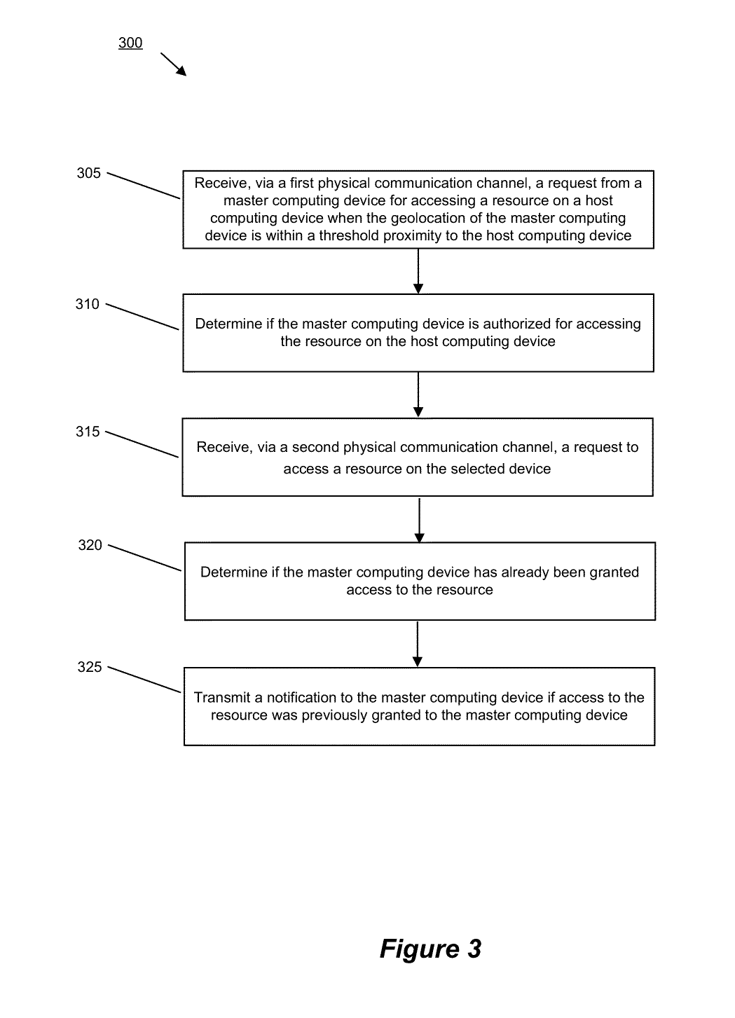

FIG. 3 conceptually illustrates an example process 300 for processing a request for ad-hoc sharing of a device over a network. The process 300 can be performed by one or more computing devices or systems in some configurations.

The process 300 beings at 305 by receiving, via a first physical communication channel, a request from a master computing device for accessing a resource on a host computing device when a geolocation of the master computing device is within a proximity threshold to the host computing device. For instance, the proximity threshold may indicate whether the host computing device is within a threshold physical distance from the master computing device to enable ad-hoc sharing of one or more resources provided by a device(s). In this regard, the host computing device includes one or more resources that are registered for sharing over a network in one example. The request may be received via a network connection established with the host computing device via a physical communication channel provided by hardware such as a network adapter (wireless, wired, Ethernet, etc.), modem, fiber optic channel, satellite, etc. Other types of physical communication channels may be provided and still be within the scope of the subject technology.

The process 300 at 310 determines if the master computing device is authorized for accessing the resource on the host computing device. In one example, determining if the master computing device is authorized for accessing the resource on the host computing device includes determining if an authorization string is included in the request from the master computing device. For instance, the authorization string can be utilized to determine that the master computing device has been authorized by the host computing device.

The process 300 at 315 receives, via a second physical communication channel, a request to access a resource on the selected device. The first and second physical communication channels are different types of communication interfaces in some configurations. Alternatively, the first and second physical communication channels are an identical type of communication interface, or the same physical communication channel in some instances. In this manner, the process 300 is enabled to utilize one or more physical communication channels, or the same physical communication channel, in order to process the request.

The process 300 at 320 determines if the master computing device has already been granted access to the resource. Determining if the master computing device has already been granted access to the resource includes receiving an authentication token granting access to the resource in one example. The authentication token may be issued by the host computing device or a web service facilitating communication between the host and master computing devices. Other types of authentication methods/schemes may be utilized and still be within the scope of the subject technology.

The process 300 at 325 transmits a notification to the master computing device if access to the resource was previously granted to the master computing device. Transmitting the notification to the master computing device includes transmitting the authentication token granting access to the resource in one example. Additionally, the notification is an acknowledgement message indicating access was previously granted in some configurations. The process 300 then ends.

Although the example process 300 in FIG. 3 describes authorizing access to a resource, it should be understood that some configurations of the subject technology may not require authorization. In such instances, access may be automatically granted to a desired resource.

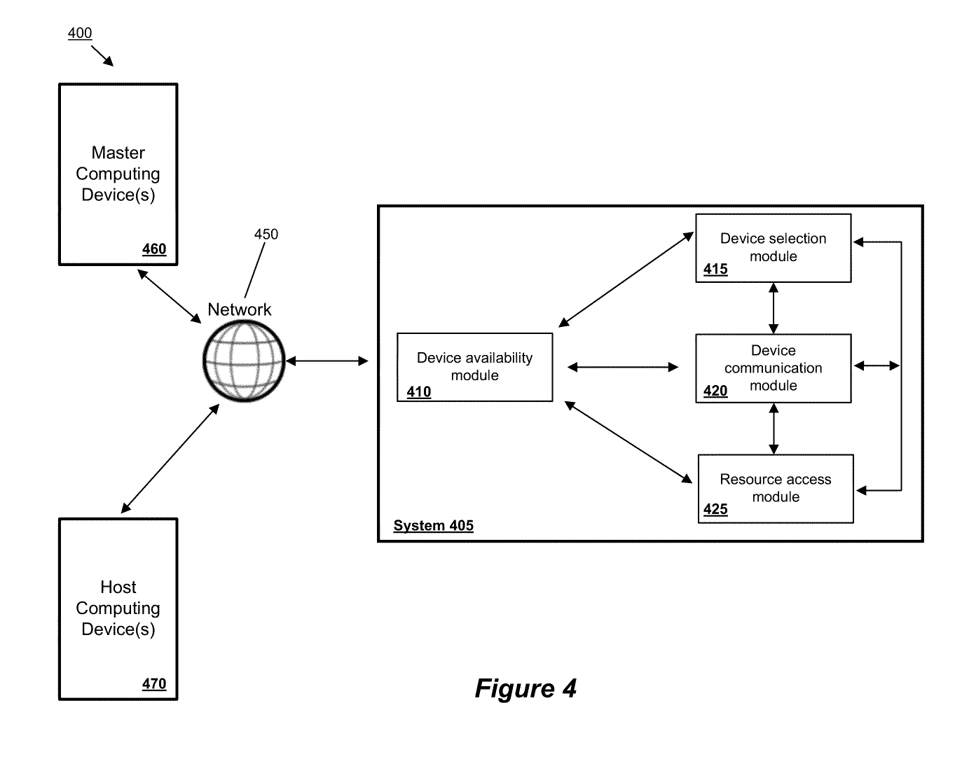

FIG. 4 conceptually illustrates an example computing environment 400 including a system. In particular, FIG. 4 shows a system 405 for implementing the above described processes in FIGS. 2 and 3. In some configurations, the system 405 is part of an implementation running a particular machine (e.g., client computer, laptop, notebook, netbook, etc.).

The system 405 can include memory, one or more processors, and one or more modules stored in memory and configured for execution by the one or more processors. As shown in FIG. 4, the system 405 includes several modules for providing different functionality. The system 405 is configured to include a device availability module 410, a device selection module 415, a device communication module 420 and a resource access module 425.

The device availability module 410 is configured to determine a plurality of host computing devices that are available for access from a master computing device, and determine a set of available resources for the determined plurality of host computing devices for access over a network. The device selection module 415 is configured to perform a selection of a device among the determined plurality of host computing devices for accessing an available resource of the set of available resources in which the selection of the device is based on a request over the network from the master computing device. The device communication module 420 is configured to determine an optimal physical communication channel for communicating with the selected device over the network in order to access the available resource.

The system 405 further includes a resource access module 425 configured to access the resource on the selected device via the determined optimal physical communication channel. The resource access module is further configured to receive, via a first physical communication channel, a request from the master computing device for accessing a resource on a host computing device in which the host computing device includes one or more resources that are registered for sharing over the network, determine if the master computing device is authorized for accessing the resource on the host computing device, receive, via a second physical communication channel, a request to access a resource on the selected device, determine if the master computing device has already been granted access to the resource, and transmit a notification to the master computing device if access to the resource was previously granted to the master computing device.

As further shown in FIG. 4, each of the aforementioned modules can be configured to communicate between each other. For instance, different data, messages, API calls and returns can be passed between the different modules in the system 405.

The system 405 can communicate over a network 450 with a master computing device(s) 460. The master computing device(s) 460 can each be configured to communicate with the aforementioned modules of the system 405. For instance, the master computing device(s) 460 can transmit a request for accessing one or more resources on a host computing device(s) 470 over the network 450 to the system 405. As further shown in FIG. 4, the system 405 can communicate over the network 450 with the host computing device(s) 470 in order to negotiate access to one or more available resources provided by the host computing device(s) 470.

Many of the above-described features and applications are implemented as software processes that are specified as a set of instructions recorded on a machine readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of machine readable media include, but are not limited to, CD-ROMs, flash drives, RAM chips, hard drives, EPROMs, etc. The machine readable media are non-transitory and do not include carrier waves and electronic signals passing wirelessly or over wired connections.

In this specification, the term “software” is meant to include firmware residing in read-only memory and/or applications stored in magnetic storage, which can be read into memory for processing by a processor. Also, in some implementations, multiple software components can be implemented as sub-parts of a larger program while remaining distinct software components. In some implementations, multiple software subject components can also be implemented as separate programs. Finally, any combination of separate programs that together implement a software component(s) described here is within the scope of the subject technology. In some implementations, the software programs, when installed to operate on one or more systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some configurations are implemented as software processes that include one or more application programming interfaces (APIs) in an environment with calling program code interacting with other program code being called through the one or more interfaces. Various function calls, messages or other types of invocations, which can include various kinds of parameters, can be transferred via the APIs between the calling program and the code being called. In addition, an API can provide the calling program code the ability to use data types or classes defined in the API and implemented in the called program code.

One or more APIs may be used in some configurations. An API is an interface implemented by a program code component or hardware component (“API implementing component”) that allows a different program code component or hardware component (“API calling component”) to access and use one or more functions, methods, procedures, data structures, classes, and/or other services provided by the API implementing component. An API can define one or more parameters that are passed between the API calling component and the API implementing component.

An API allows a developer of an API calling component (that could be a third party developer) to utilize specified features provided by an API implementing component. There may be one API calling component or there may be more than one such component. An API can be a source code interface that a computing system or program library provides to support requests for services from an application. An operating system (OS) can have multiple APIs to allow applications running on the OS to call one or more of those APIs, and a service (such as a program library) can have multiple APIs to allow an application that uses the service to call one or more of those APIs. An API can be specified in terms of a programming language that can be interpreted or compiled when an application is built.

In some configurations the API implementing component may provide more than one API, each providing a different view of or with different aspects that access different aspects of the functionality implemented by the API implementing component. For example, one API of an API implementing component can provide a first set of functions and can be exposed to third party developers, and another API of the API implementing component can be hidden (not exposed) and provide a subset of the first set of functions and also provide another set of functions, such as testing or debugging functions which are not in the first set of functions. In other configurations the API implementing component may itself call one or more other components via an underlying API and thus be both an API calling component and an API implementing component.

An API defines the language and parameters that API calling components use when accessing and using specified features of the API implementing component. For example, an API calling component accesses the specified features of the API implementing component through one or more API calls or invocations (embodied for example by function or method calls) exposed by the API and passes data and control information using parameters via the API calls or invocations. The API implementing component may return a value through the API in response to an API call from an API calling component. While the API defines the syntax and result of an API call (e.g., how to invoke the API call and what the API call does), the API may not reveal how the API call accomplishes the function specified by the API call. Various API calls are transferred via the one or more application programming interfaces between the calling (API calling component) and an API implementing component. Transferring the API calls may include issuing, initiating, invoking, calling, receiving, returning, or responding to the function calls or messages. In other words, transferring can describe actions by either of the API calling component or the API implementing component. The function calls or other invocations of the API may send or receive one or more parameters through a parameter list or other structure. A parameter can be a constant, key, data structure, object, object class, variable, data type, pointer, array, list or a pointer to a function or method or another way to reference a data or other item to be passed via the API.

Furthermore, data types or classes may be provided by the API and implemented by the API implementing component. The API calling component therefore can declare variables, use pointers to, use or instantiate constant values of such types or classes by using definitions provided in the API.

Generally, an API can be used to access a service or data provided by the API implementing component or to initiate performance of an operation or computation provided by the API implementing component. By way of example, the API implementing component and the API calling component may each be any one of an operating system, a library, a device driver, an API, an application program, or other module (it should be understood that the API implementing component and the API calling component may be the same or different type of module from each other). API implementing components may in some cases be embodied at least in part in firmware, microcode, or other hardware logic. In some configurations, an API may allow a client program to use the services provided by a Software Development Kit (SDK) library. In other configurations an application or other client program may use an API provided by an Application Framework. In these configurations the application or client program may incorporate calls to functions or methods provided by the SDK and provided by the API or use data types or objects defined in the SDK and provided by the API. An Application Framework may in these configurations provide a main event loop for a program that responds to various events defined by the Framework. The API allows the application to specify the events and the responses to the events using the Application Framework. In some implementations, an API call can report to an application the capabilities or state of a hardware device, including those related to aspects such as input capabilities and state, output capabilities and state, processing capability, power state, storage capacity and state, communications capability, etc., and the API may be implemented in part by firmware, microcode, or other low level logic that executes in part on the hardware component.

The API calling component may be a local component (i.e., on the same data processing system as the API implementing component) or a remote component (i.e., on a different data processing system from the API-implementing component) that communicates with the API-implementing component through the API over a network. It should be understood that an API implementing component may also act as an API calling component (i.e., it may make API calls to an API exposed by a different API implementing component) and an API calling component may also act as an API implementing component by implementing an API that is exposed to a different API calling component.

The API can allow multiple API calling components written in different programming languages to communicate with the API implementing component (thus the API may include features for translating calls and returns between the API implementing component and the API calling component). The API however can be implemented in terms of a specific programming language. An API calling component can, in one configuration, call APIs from different providers such as a set of APIs from an OS provider and another set of APIs from a plug-in provider and another set of APIs from another provider (e.g. the provider of a software library) or creator of the another set of APIs.

The following description describes an example API architecture in which some configurations of the subject technology can be implemented.

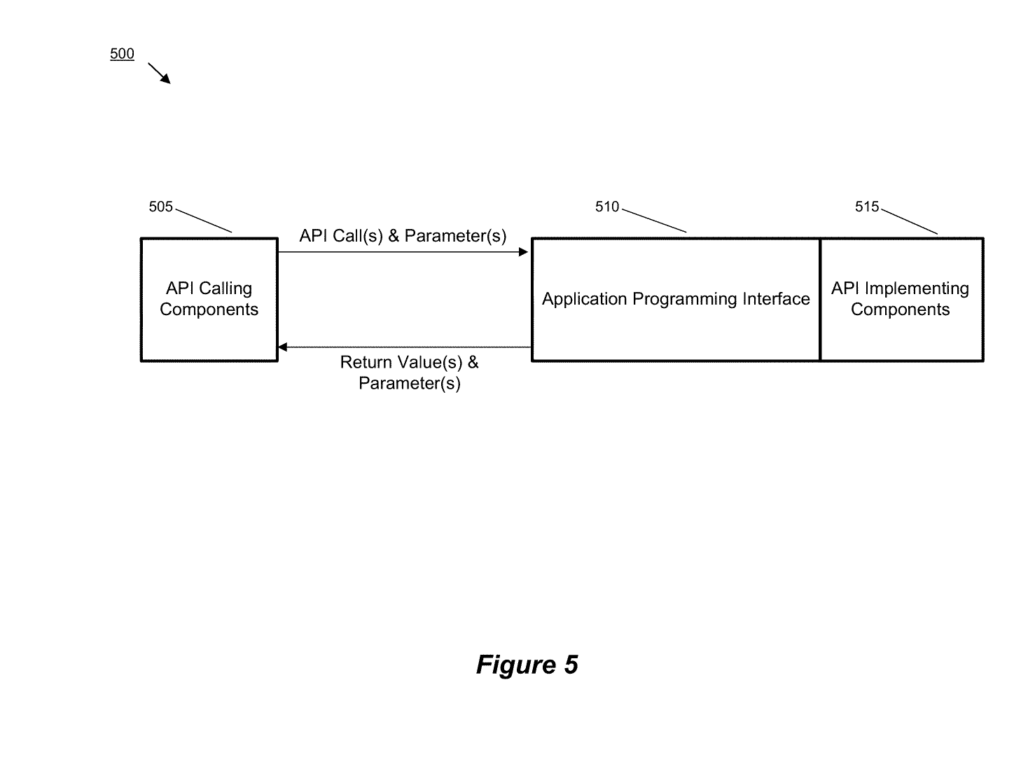

FIG. 5 is a block diagram illustrating an example API architecture, which can be used in some configurations of the subject technology. As shown in FIG. 5, the API architecture 500 includes the API implementing component 515 (e.g., an operating system, a library, a device driver, an API, an application program, software or other module) that implements the API 510. The API 510 specifies one or more functions, methods, classes, objects, protocols, data structures, formats and/or other features of the API-implementing component that can be used by the API-calling component 505. The API 510 can specify at least one calling convention that specifies how a function in the API implementing component receives parameters from the API calling component and how the function returns a result to the API calling component. The API calling component 505 (e.g., an operating system, a library, a device driver, an API, an application program, software or other module), makes API calls through the API 510 to access and use the features of the API implementing component 515 that are specified by the API 510. The API implementing component 515 can return a value through the API 510 to the API calling component 505 in response to an API call.

It will be appreciated that the API implementing component 515 can include additional functions, methods, classes, data structures, and/or other features that are not specified through the API 510 and are not available to the API calling component 505. It should be understood that the API calling component 505 can be on the same system as the API implementing component 515 or can be located remotely and accesses the API implementing component 515 using the API 510 over a network. While FIG. 5 illustrates a single API calling component 505 interacting with the API 510, it should be understood that other API calling components, which can be written in different languages (or the same language) than the API calling component 505, can use the API 510.

The API implementing component 515, the API 510, and the API calling component 505 can be stored in a machine-readable medium, which includes any mechanism for storing information in a form readable by a machine (e.g., a computer or other data processing system). For example, a machine-readable medium includes magnetic disks, optical disks, random access memory, read only memory, flash memory devices, etc.

The following description describes an example system in which aspects of the subject technology can be implemented.

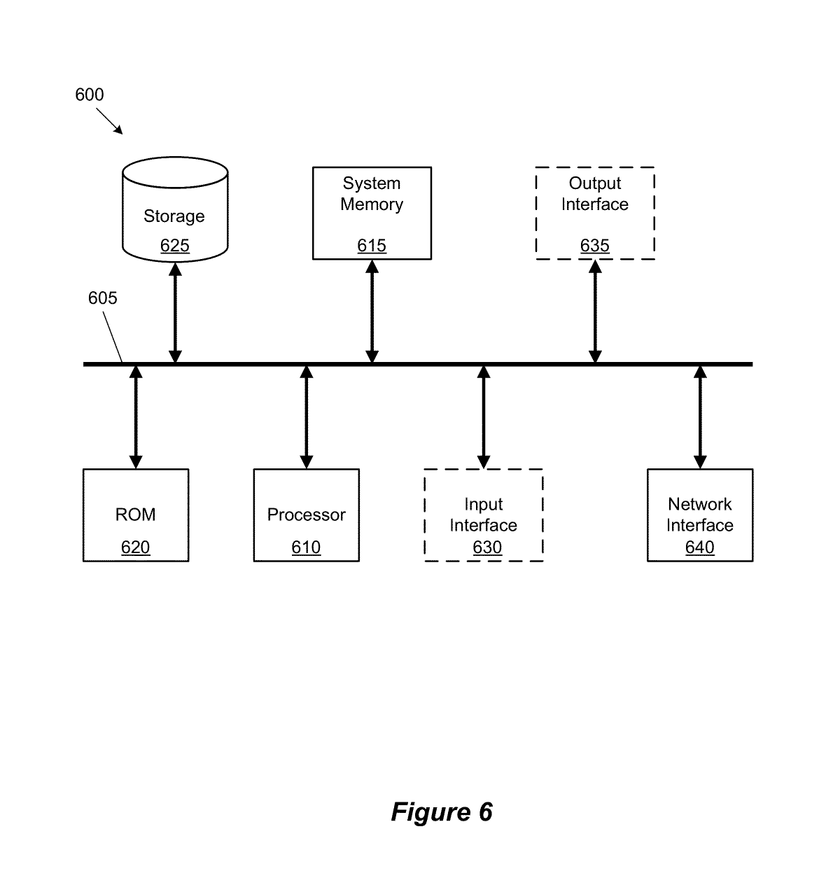

FIG. 6 conceptually illustrates a system 600 with which some implementations of the subject technology can be implemented. The system 600 can be a computer, phone, PDA, or any other sort of electronic device. In some configurations, the system 600 includes a television with one or more processors embedded therein. Such a system includes various types of computer readable media and interfaces for various other types of computer readable media. The system 600 includes a bus 605, processing unit(s) 610, a system memory 615, a read-only memory 620, a storage device 625, an optional input interface 630, an optional output interface 635, and a network interface 640.

The bus 605 collectively represents all system, peripheral, and chipset buses that communicatively connect the numerous internal devices of the system 600. For instance, the bus 605 communicatively connects the processing unit(s) 610 with the read-only memory 620, the system memory 615, and the storage device 625.

From these various memory units, the processing unit(s) 610 retrieves instructions to execute and data to process in order to execute the processes of the subject technology. The processing unit(s) can be a single processor or a multi-core processor in different implementations.

The read-only-memory (ROM) 620 stores static data and instructions that are needed by the processing unit(s) 610 and other modules of the system 600. The storage device 625, on the other hand, is a read-and-write memory device. This device is a non-volatile memory unit that stores instructions and data even when the system 600 is off. Some implementations of the subject technology use a mass-storage device (such as a magnetic or optical disk and its corresponding disk drive) as the storage device 625.

Other implementations use a removable storage device (such as a flash drive, a floppy disk, and its corresponding disk drive) as the storage device 625. Like the storage device 625, the system memory 615 is a read-and-write memory device. However, unlike storage device 625, the system memory 615 is a volatile read-and-write memory, such a random access memory. The system memory 615 stores some of the instructions and data that the processor needs at runtime. In some implementations, the subject technology's processes are stored in the system memory 615, the storage device 625, and/or the read-only memory 620. For example, the various memory units include instructions for processing multimedia items in accordance with some implementations. From these various memory units, the processing unit(s) 610 retrieves instructions to execute and data to process in order to execute the processes of some implementations.

The bus 605 also connects to the optional input and output interfaces 630 and 635. The optional input interface 630 enables the user to communicate information and select commands to the system. The optional input interface 630 can interface with alphanumeric keyboards and pointing devices (also called “cursor control devices”). The optional output interface 635 can provide display images generated by the system 600. The optional output interface 635 can interface with printers and display devices, such as cathode ray tubes (CRT) or liquid crystal displays (LCD). Some implementations can interface with devices such as a touchscreen that functions as both input and output devices.

Finally, as shown in FIG. 6, bus 605 also couples system 600 to a network interface 640 through a network adapter (not shown). In this manner, the computer can be a part of a network of computers (such as a local area network (“LAN”), a wide area network (“WAN”), or an Intranet, or an interconnected network of networks, such as the Internet. Any or all components of system 600 can be used in conjunction with the subject technology.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to non-transitory, tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Configurations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some configurations, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes can be rearranged, or that all illustrated steps be performed. Some of the steps can be performed simultaneously. For example, in certain circumstances, multitasking and parallel processing can be advantageous. Moreover, the separation of various system components in the configurations described above should not be understood as requiring such separation in all configurations, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein can be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase such as an “aspect” does not imply that such aspect is essential to the subject technology or that such aspect applies to all configurations of the subject technology. A disclosure relating to an aspect can apply to all configurations, or one or more configurations. A phrase such as an aspect can refer to one or more aspects and vice versa. A phrase such as a “configuration” does not imply that such configuration is essential to the subject technology or that such configuration applies to all configurations of the subject technology. A disclosure relating to a configuration can apply to all configurations, or one or more configurations. A phrase such as a configuration can refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

What is claimed is:

1. A computer-implemented method for ad-hoc sharing of devices, the method comprising:
determining a plurality of host computing devices that are available for access from a master computing device;
determining a set of available resources for the determined plurality of host computing devices;
selecting a device among the determined plurality of host computing devices for accessing an available resource of the set of available resources;
determining an optimal physical communication channel for accessing the available resource on the selected device; and
accessing the resource on the selected device via the determined optimal physical communication channel.

2. The method of claim 1, wherein determining the plurality of host computing devices is based on a geolocation of a user.

3. The method of claim 1, wherein determining a plurality of host computing devices that are available for access from the master computing device occurs over a network infrastructure.

4. The method of claim 1, wherein the optimal physical communication channel comprises a network connection.

5. The method of claim 4, wherein the network connection is included in a local area network or ad-hoc network.

6. The method of claim 4, wherein the network connection is included in a wide area network or network of networks.

7. The method of claim 1, wherein the optimal physical communication channel comprises an end-to-end communication channel.

8. The method of claim 1, wherein the devices includes at least one input device and one output device.

9. The method of claim 8, wherein the one output device is a monitor.

10. The method of claim 1, wherein the available resource comprises a display component, an audio component or a networking component of the device.

11. The method of claim 1, wherein accessing the resource on the selected device comprises:
transmitting data over the network for display on a display component of the selected device.

12. The method of claim 1, wherein determining the optimal physical communication channel for accessing the available resource on the selected device comprises:
determining an optimal channel based on a plurality of criteria.

13. The method of claim 12, wherein the plurality of criteria includes available bandwidth, signal strength, signal quality, and latency.

14. A computer-implemented method for processing a request for ad-hoc sharing of a device, the method comprising:
receiving, via a first physical communication channel, a request from a master computing device for accessing a resource on a host computing device when a geolocation of the master computing device is within a proximity threshold to the host computing device, wherein the host computing device includes one or more resources that are registered for sharing over a network;
determining if the master computing device is authorized for accessing the resource on the host computing device;
receiving, via a second physical communication channel, a request to access a resource on the selected device;
determining if the master computing device has already been granted access to the resource; and
transmitting a notification to the master computing device if access to the resource was previously granted to the master computing device.

15. The method of claim 14, wherein determining if the master computing device is authorized for accessing the resource on the host computing device comprises:
determining if an authorization string is included in the request from the master computing device.

16. The method of claim 14, wherein determining if the master computing device has already been granted access to the resource comprises receiving an authentication token granting access to the resource.

17. The method of claim 16, wherein transmitting the notification to the master computing device comprises:
transmitting the authentication token granting access to the resource.

18. The method of claim 14, wherein the first and second physical communication channels comprise different types of communication interfaces.

19. The method of claim 14, wherein the first and second physical communication channels comprise an identical type of communication interface.

20. A system for ad-hoc sharing of devices, the system comprising:
memory;
one or more processors;
one or more modules stored in memory and configured for execution by the one or more processors, the modules comprising:
a device availability module configured to determine a plurality of host computing devices that are available for access from a master computing device, and determine a set of available resources for the determined plurality of host computing devices for access over a network;
a device selection module configured to perform a selection of a device among the determined plurality of host computing devices for accessing an available resource of the set of available resources, wherein the selection of the device is based on a request over the network from the master computing device; and
a device communication module configured to determine an optimal physical communication channel for communicating with the selected device over the network in order to access the available resource.

21. The system of claim 20, further comprising:
a resource access module configured to access the resource on the selected device via the determined optimal physical communication channel.

22. The system of claim 21, wherein the resource access module is further configured to:
receive, via a first physical communication channel, a request from the master computing device for accessing a resource on a host computing device, wherein the host computing device includes one or more resources that are registered for sharing over the network;
determine if the master computing device is authorized for accessing the resource on the host computing device;
receive, via a second physical communication channel, a request to access a resource on the selected device;
determine if the master computing device has already been granted access to the resource; and
transmit a notification to the master computing device if access to the resource was previously granted to the master computing device.

23. A non-transitory machine-readable medium comprising instructions stored therein, which when executed by a machine, cause the machine to perform operations comprising:
determining a plurality of host computing devices that are available for access from a master computing device;
determining a set of available resources for the determined plurality of host computing devices;
selecting a device among the determined plurality of host computing devices for accessing an available resource of the set of available resources based on a request from the master computing device; and
determining an optimal physical communication channel for accessing the available resource on the selected device.

24. The non-transitory machine-readable medium of claim 23, comprising further instructions stored therein, which when executed by the machine, cause the machine to perform further operations comprising:
determining if the master computing device is authorized for accessing the available resource on the selected device; and
accessing the available resource on the selected device via the determined optimal physical communication channel if the master computing device is authorized.
